(19) United States
(12) Patent Application Publication
(10) Pub. No.: US 2025/0240303 A1
(43) Pub. Date: Jul. 24, 2025

(54) ANALYTICS-DEFINED PERIMETERS FOR ZERO TRUST ARCHITECTURES

(71) Applicant: Dell Products L.P., Round Rock, TX (US)

(72) Inventors: Werner Spolidoro Freund, Rio de Janeiro (BR); Roberto Nery Stelling Neto, Rio de Janeiro (BR); Vicente J.P. Amorim, João Monlevade (BR); Thais Luca Marques de Almeida, São Gonçalo (BR); Fabricio Matheus Takaki, Valinhos (BR)

(21) Appl. No.: 18/420,645

(22) Filed: Jan. 23, 2024

(51) Int. Cl. H04L 9/40

(52) U.S. Cl. CPC H04L 63/107; H04L 63/102; H04L 63/20

(57) ABSTRACT

One example method includes collecting telemetry concerning an activity occurring in an IT infrastructure, updating an activity database with the telemetry, applying a rule to determine if the activity is associated with a crossing of an analytics-defined perimeter (ADP) within the IT infrastructure, when a perimeter crossing has been determined to have occurred, applying a policy to determine whether, and what, action should be taken with respect to the perimeter crossing, and implementing an action with respect to an entity whose activity is being evaluated when the perimeter crossing is determined to be contrary to the policy.

### FIELD OF THE INVENTION

Embodiments of the present invention generally relate to zero trust (ZT) architectures. More particularly, at least some embodiments of the invention relate to systems, hardware, software, computer-readable media, and methods, for using analytics to define, and enforce, perimeters in ZT architectures.

### BACKGROUND

The DoD Reference Architecture for Zero-Trust Architectures (ZTA) defines several postures that must be employed in order to increase network cybersecurity. Activities are only authorized in the network by Policy Enforcement Points (PEPs) as the result of the policy evaluations performed in the Policy Decision Point (PDPs). As they are aimed at reducing the size of the surface that can be affected by a malicious agent as the result of erroneous authorization of network activities, ZTAs are required to achieve micro-segmentation. In other words, ZTAs must acquire the ability to segment the network in thin granularity regions where lateral movement from one region to another is authorized by PEPs.

However, achieving Zero Trust (ZT) micro-segmentation is not straightforward. Brownfield scenarios consider its adoption from existing infrastructures. Organizations are under constant threat by malicious actors and are subject to limited budget, so cost efficient and fast-to-implement solutions are required. Most efforts to achieve micro-segmentation have focused on strategies based on Software-Defined Perimeters (SDPs). In a Brownfield scenario, this approach requires direct interventions in the network infrastructure to ensure the desired control posture, that is, interventions in the network achieved through the usage of service meshes, service proxies and/or reverse proxies, for example.

In more detail, reliance solely on SDPs for use in managing network activity may be problematic for a variety of reasons. For example, such an approach may result in suboptimal solutions both financially and technically as the result of additional implementation efforts. As another example, an approach using only SDPs may be unfeasible to implement, for example, when dealing with operational systems (OS) or third-party applications/networks where performing modifications to an SDP is either impossible or requires excessive effort. Further, reliance solely on SDPs typically requires modifications in the network whenever access policies become of thinner granularity than current available SDP-based enforcement points. As well, in an SDP-only approach, an SDP can become unavailable, without recourse to other options, if the corresponding PEP becomes unresponsive for some reason. Finally, an SDP-only approach can result in fixed segmentation in SDP implementation boundaries and can require changes in the network structure in order to be able to modify perimeters.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example ZT architecture in which an embodiment may be implemented.

FIG. 2 discloses aspects of an example ontology such as may be employed in an embodiment.

FIG. 3 discloses an example ontology comprising reasoning features, according to an embodiment.

FIG. 4 discloses an architecture and corresponding method, according to an embodiment.

FIG. 5 discloses an example computing entity configured and operable to perform any of the disclosed methods, processes, and operations.

### DETAILED DESCRIPTION OF SOME EXAMPLE EMBODIMENTS

Embodiments of the present invention generally relate to zero trust (ZT) architectures. More particularly, at least some embodiments of the invention relate to systems, hardware, software, computer-readable media, and methods, for using analytics to define, and enforce, perimeters in ZT architectures.

One example embodiment comprises a method. This example method may comprise various operations, including: collecting telemetry concerning an activity occurring in a network; updating an activity database with the telemetry; applying a reasoning rule to determine if the activity is associated with the crossing of an analytics-defined perimeter within the network; when a perimeter crossing has been determined to have occurred, applying a policy to determine whether, and what, action should be taken with respect to the perimeter crossing; and, implementing an action with respect to the entity whose activity is being evaluated when the perimeter crossing is determined to be contrary to the policy.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that perimeter boundaries, defined using analytics, may be flexibly defined, implemented, and modified, within a network. In an embodiment, a perimeter boundary may be dynamically defined and modified as conditions within the network change. Various other advantages of one or more example embodiments will be apparent from this disclosure.

### A. Context for an Example Embodiment

The following is a discussion of aspects of a context for an example embodiment. This discussion is not intended to limit the scope of the invention, or the applicability of the embodiments, in any way.

### A.1 Zero Trust Architecture (ZTA)

Aspects of one or more example ZTAs in connection with which an embodiment may be implemented are set forth in DISA and NSA, ‘Department of Defense Zero Trust Reference Architecture.’ The aforementioned document, which is hereby incorporated by reference, is found at: //dodcio.defense.gov/Portals/0/Documents/Library/(U)ZT_RA_v2.0(U)_Sep22.pdf. One embodiment of the invention comprises the definition of authorization perimeters in a ZTA after a user is authenticated in the network.

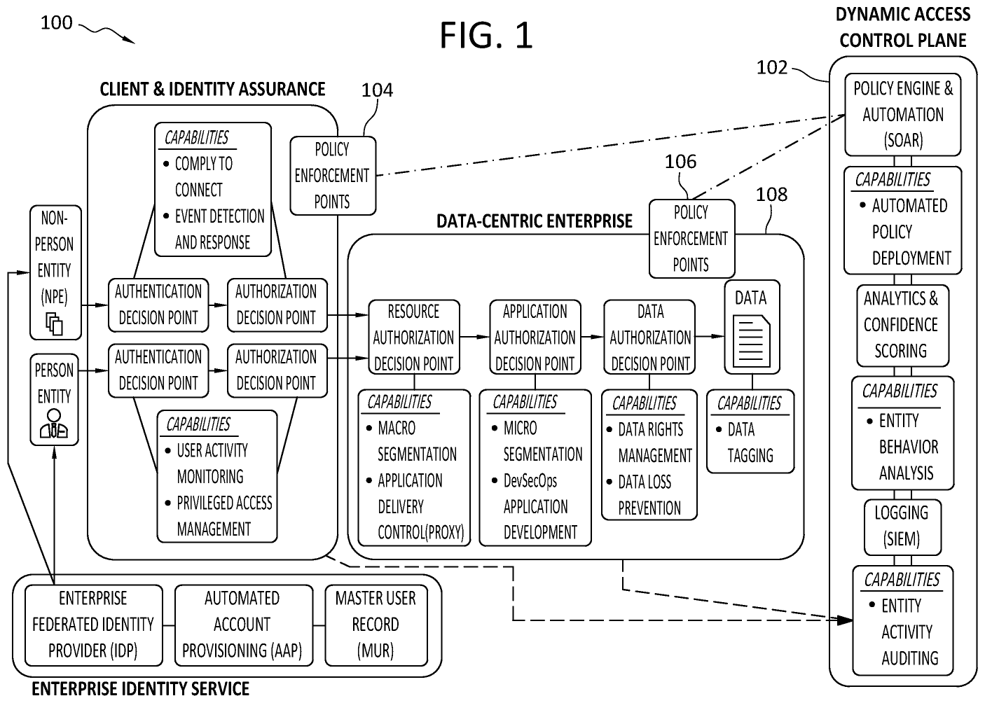

With attention now to FIG. 1, a Zero Trust Reference Architecture 100 and corresponding PEP perimeters are disclosed, where such PEP perimeters comprise, in this example: network access; resource access; application access; and, data access. More generally, a dynamic access control plane 102 may operate in connection with PEPs relating to various aspects of the operation of an enterprise and, accordingly, PEPs 104 may be implemented with respect to client and identity assurance, and PEPs 106 may be implemented with respect to operations of a data-centric enterprise 108.

As noted above, one conventional approach involves the implementation of dedicated software in order to verify access by entities to network resources such as data for example. This approach thus requires the usage of specialized software infrastructure for locally intercepting and only allowing activity flow within the network as an in-place switch. High-level switches may be available in the network so that obtaining observability is enough to ensure network activities respect defined perimeters through the usage of the available switches as PEPs. By way of contrast, an embodiment may approach the problem of network segmentation through evaluation of policies on top of the network state representation and usage of the available high-level PEPs to ensure that activities are executed only within accepted perimeters.

### A.2 Network Observability and State Representation

One embodiment implements the concept that retrieving observability and representing its current state is generally a more practical approach than directly implementing infrastructure, such as service meshes for example, to control activity in the network itself. Most operational systems and applications provide out-of-the-shell information about their current states that can be used for achieving network control. There are tools available to take advantage of such information and keep track of the activities being performed in the environment. Examples of such tools are disclosed in “Kurniawan, K., Ekelhart, A., Kiesling, E., Quirchmayr, G., Tjoa, A. M., 2022. KRYSTAL: Knowledge graph-based framework for tactical attack discovery in audit data. Computers & Security 121, 102828. https://doi.org/10.1016/j.cose.2022.102828” (“Kurniawan”) and in “cyBERT 2.0—Streaming GPU log parsing with RAPIDS|by Rachel Allen|RAPIDS AI|Medium” (“cyBERT”), both of which are incorporated herein by this reference. As well, approaches for observing and ingesting general telemetry data are disclosed at “https://opentelemetry.io/,” (“Telemetry”) incorporated herein by this reference.

One embodiment may reduce the effort for achieving network segmentation by building on top of Kurniawan, cyBERT, and Telemetry. Depending on the network observability employed, one embodiment may not lead to the highest ZT maturity levels but may nonetheless represent considerable improvements with respect to previous maturity level with much less effort associated than, for example, using a conventional SDP-only approach. In other words, an embodiment may collect system and application logs to segment the network without requiring additional changes to the applications and operational system software. An embodiment may also enhance the observability to reach higher maturity levels. In this regard, it is noted that high network observability may be required in any event to derive ZT analytics and automation pillars, so achieving segmentation using the network state representation, as is done in one example embodiment, does not imply additional efforts, but may then evaluate perimeter violations and communicating with a corresponding PEPs to handle those violations, as disclosed below.

### A.3 Knowledge Graphs

An embodiment may be configured and implemented in which the telemetry data is eventually consumed by a Knowledge Graph (KG). The KG is a conceptual information representation of a fact, such as network activity in one example. A KG may be built upon many different already existing storages, such as relational databases, graph databases, and triple stores. Additionally, the KG may provide a flexible database that can efficiently consume irregular and arbitrary data points and, as such, may be employed to store cybersecurity data from various source and granularity levels. To facilitate clarity in the present disclosure, an example embodiment of a KG is discussed in terms of the use of a triple store, although the scope of the invention is not limited to triple stores.

### A.3.1 Triple Stores

In an example triple store according to one embodiment, each activity telemetry, that is, the telemetry concerning a particular activity, may be registered as a set of tuples in the format (s,p,o) called ‘triple,’ where s stands for subject, o for object, and p for predicate. For instance, an activity of a user U aiming to install an application A in the network would be registered as the tuple of triples [(U,is_a,User),(A,is_a,Application),(U,access,A)], readable as “a user U accesses an application A.”

### A.3.2 Ontology

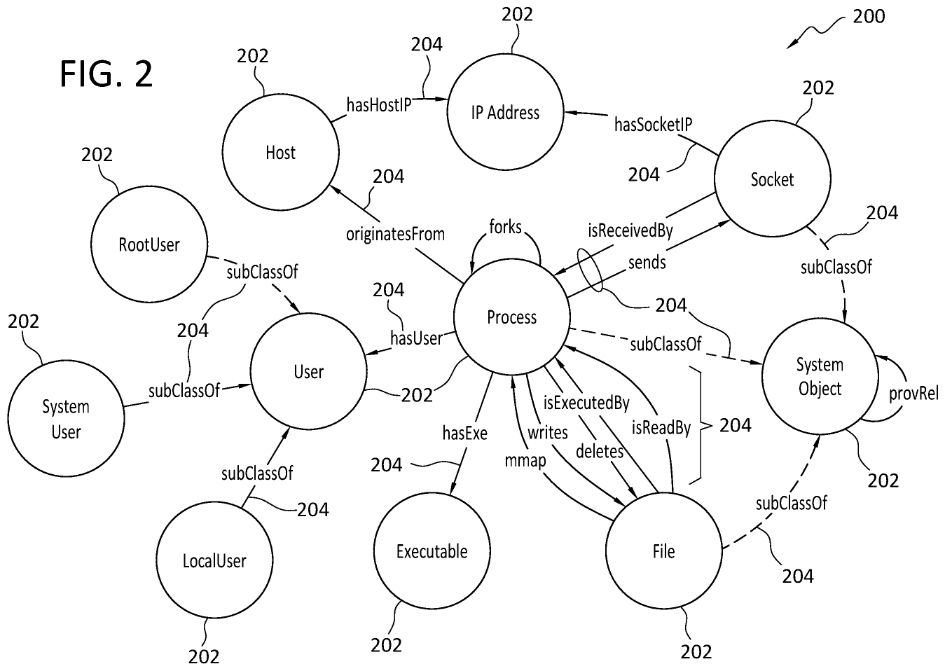

In an embodiment, a KG may be complemented with high-level semantic information that specifies how the entities and relationships are governed within the database. This specification is defined on so-called ontologies and encompass elements such as classes, properties, formal naming, among others. With reference now to FIG. 2, and example ontology 200 is disclosed that may be defined and employed to represent system log data. More specifically, the ontology 200 of FIG. 2 may comprise a Krystal Ontology, and may include nodes, some examples of which are denoted at 202, that represent system-level entities, and edges, some examples of which are denoted at 204, representing possible relationships between two or more nodes 202. As discussed below, ontologies, such as the example ontology 200, may also provide reasoning capabilities.

### A.3.3 Reasoning Frameworks

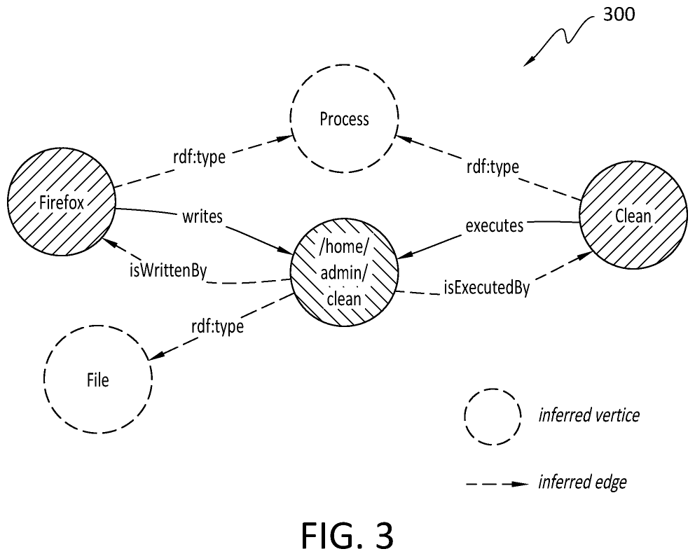

FIG. 3 discloses some examples of ontology 300 reasoning features. Reasoning frameworks may be used for evaluating policies and defining perimeters on top of KG technology. Several reasoning mechanisms can be employed, such as SQL queries in case of relational databases, GraphQL queries in case of graph databases, SPARQL or Gremlin in case of triple stores, and Prolog interpreters by reasoning over the existing rules. The scope of the invention is not limited to any particular reasoning framework or mechanism however.

By way of example, suppose the following system log telemetry information is collected, as depicted in the example of FIG. 3: [(Firefox, writes, /home/admin/clean), (Clean, executes, /home/admin/clean)]. Ontology reasoning capabilities (see Kurniawan) may permit the inference that [(/home/admin/clean, is_a, File), (Firefox, is_a, Process), (Clean, is_a, Process)] and that [(/home/admin/clean, isWrittenBy, Firefox), (/home/admin/clean, isExecutedBy, Clean)].

By leveraging such ontology reasoning capabilities, an embodiment may obtain useful information from the activity to determine which PEP type is to be evaluated:
/home/admin/clean is a file and any activity associated with it must be compliant to be allowed for such perimeter; and
Firefox is a process—thus, activities may be associated with an application perimeter and, further, more complex reasoning rules may be defined and implemented by an embodiment to properly specify a perimeter, for example:
   (User, executes, Process) may be used to determine perimeter boundaries for only specific users being able to execute a particular application; and/or
   [(User, access, data), (data, isWrittenBy, Process)] may be used to specify perimeter boundaries that only particular users can access data of a particular process.

### B. Overview of Aspects of an Example Embodiment

Verifying network activity compliance with rules and policies is a common practice in Security Information and Event Monitoring (SIEM) systems. These systems focus on signature-based analytics in which activities are matched against traces, typically left by malicious actors, to raise suspicious activity events. At present however, there is no known approach involving, as an example embodiment does, the usage of network state representation for determining access authorization nor to improve the network segmentation as required by ZT.

Current PEP efforts are based on direct interventions in the network architecture and have policies implemented as code. By way of contrast, an embodiment may be implemented directly on current observability. As well, one embodiment may benefit from interventions to increase network observability but, as discussed, such interventions require less effort than adding, as in a conventional approach, software that is capable of observing, intercepting, and taking decisions on the network activities.

Thus, an example embodiment may comprise an approach to solve the aforementioned, and/or other, problems and achieve improvements at scale in ZT maturity levels on Brownfield scenarios with lower technical and financial efforts. An embodiment may thus enrich the possibilities to achieve higher ZTA maturity levels and may be used to enhance activity control of an entity and its client networks.

It is noted that an embodiment may decouple the concepts of achieving thin-granularity network observability from the implementation of thin-granularity access control, that is, the availability of PEP at granularity level of the perimeter definition. In an embodiment, the first is enough to ensure the latter by evaluating access policies on the network state representation built on top of its activity observations. Such a network segmentation process may be referred to herein as being performed through the use of Analytics-Defined Perimeters (ADPs) since a decoupling process focuses on the aspects of data representation and data processing. An ADP-based decision, therefore, may verify the access policies on the network state representation, rather than directly intercepting activities in the network.

In an approach according to one embodiment, perimeters are defined as part of the policies themselves, while policies may simply be a type of data which can be processed and modified as required. In other words, an embodiment may dynamically implement flexible perimeter definitions which can provide several advantages such as, but not limited to, dynamic segmentation and segmentation optimization. It is noted further that a decoupling process according to one embodiment may be largely, and ADPs may enable a more general way to achieve segmentation in ZTAs, at least because:
observability at the same granularity level than the policy enforcement is required for access control to be effective—that is, SDP definition implies the ability to achieve observability at the required granularity level that would allow resorting to ADP, but at the same time implementing the software modification in the network;
telemetry is generally more available or easier to obtain than directly intervening on the network architecture;
not all network telemetry retrieving points must have an authorization software associated since the acquired telemetry may simply be a fraction of a more complex access policy, for example, a policy depending on the output of a model fed from a sequence of activities; and
as previously discussed, the perimeter boundaries can be adapted, possibly dynamically, by adjusting the data processing scheme.

In an embodiment, an ADP-based decision may be based on a lazy evaluation strategy which may have its pros and cons. For example, while a lazy evaluation strategy may ensure better user experience, as the network activity flow is not subject to additional latency from the conditional access evaluations, the lazy evaluation strategy may result in some security limitations as an attacker can attempt to exploit temporary access to perform malicious actions such as reconnaissance or data exfiltration. In an embodiment, this limitation of a lazy evaluation strategy may be mitigated by:
ensuring low-latency ADP enforcement that, in practice, has the same, or nearly the same, effect as an SDP implementation;
relying on ADPs for non-critical network regions; and
combining ADP and SDP strategies, relying only on SDP-based enforcement whenever required.

This way, an embodiment may increase overall network ZT maturity levels and focus on implementing software-based interventions on most critical areas. A method according to one embodiment may proceed as follows:
Network telemetry is gathered and integrated in an activity database;
Whenever a new activity is observed, the activity is directed to the corresponding ADP-based PDP for a decision (for example, user, device, network, application, data);
Each ADP-based PDP contains a set of policies determining access control that are represented as data and, therefore, kept in a corresponding policy database;
The ADP-based PDP evaluates the incoming activity information in the database against available policies and determines whether it is compliant; and
The decision is forwarded to the corresponding PEP which follows a pre-specified procedure such as, for example, revoke user access to data or to a network resource.
   Below, an embodiment is discussed that is able to achieve ADP-based micro-segmentation for ZTAs using Knowledge Graphs (KGs).

As disclosed herein then, an embodiment may comprise various useful features and aspects, although no embodiment is required to possess any of such features and aspects. Following are some illustrative examples. In an embodiment, an ADP approach determines conditional access authorization based on network state representation. An embodiment of an ADP approach does not require local PEPs for perimeter definition but requires only the availability of observability at the perimeter boundaries. An embodiment of an ADP approach may enable flexible and dynamic network segmentation. An embodiment of an ADP approach may be based on lazy policy verification, which may be a beneficial aspect in some use cases. Finally, an embodiment of an ADP approach may employ policies that are represented as data and available in a database, which enables their usage by downstream processing.

### C. Detailed Discussion of Aspects of an Example Embodiment

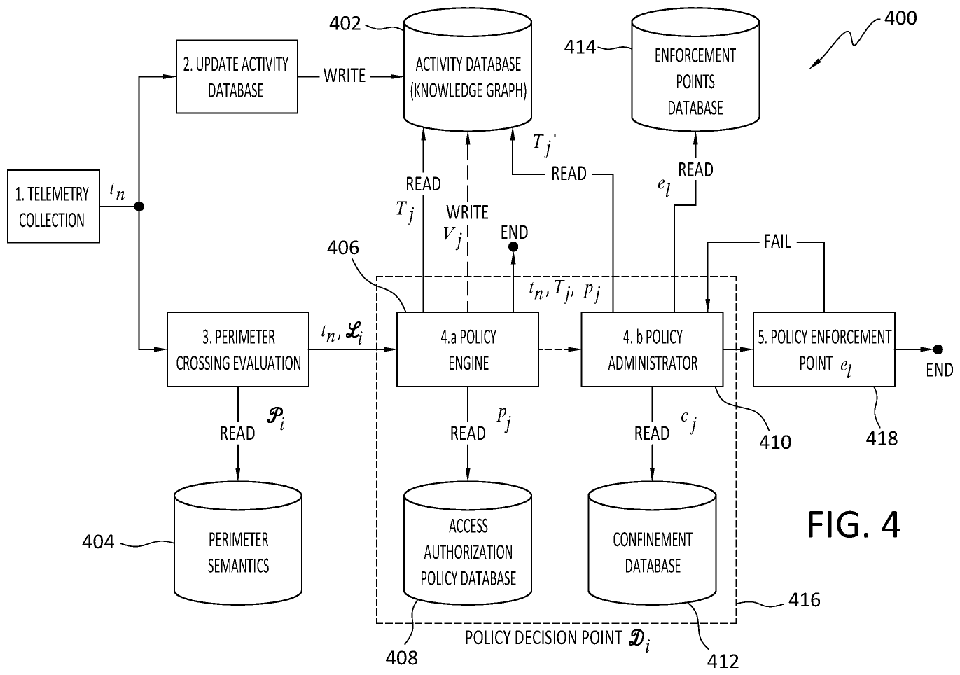

Initially, a discussion is presented as to how, in one embodiment, KG technology may be applied to enable the definition and use of ADPs. FIG. 4 depicts an example architecture 400 and associated workflow, according to one embodiment, to achieve ADP, in which various components may be employed:

### 1. Telemetry Collection:

a. It was noted earlier herein that retrieving (1) network telemetry is generally easier than directly implementing software infrastructure to locally enforce activity control—to this end, various tools may be employed, some of which may be represented in a KG. As also noted earlier, KG technology provides a flexible representation, and may be used to capture heterogeneous network information and represent that network information in an interconnected database.
b. Therefore, let tₙ=(sₙ,pₙ,oₙ) be the representation of an activity observed in the network.

### 2. Update Activity Database:

a. An activity database 402, which may comprise, or be implemented as, a KG in an embodiment, may be updated (2) as soon as possible with the obtained telemetry from activity tₙ. The evaluation of activity authorization occurs in parallel starting with step 3 described next.

### 3. Evaluating Perimeter Crossing Types:

a. Reasoning rules can be used to enrich activity information with additional perimeter semantics, possibly obtained from a perimeter semantics database 404 for example, as described earlier herein. An embodiment may exploit such properties to evaluate (3) whether an activity is associated with the crossing of a perimeter in the network.
b. Let a reasoning rule be denoted by [symbol] ᵢ(tₙ)→tₙ∈ [symbol] ᵢ, where the → symbol is employed to map the conclusion when the premises of rule [symbol] ᵢ are true and [symbol] ᵢ defines the perimeter crossing type. Using the ontology example disclosed in FIG. 3, possible premises could be [(oₙ, isSubClassOf, File), (pₙ, isSubClassOf, (writes, deletes)] to evaluate whether the data perimeter [symbol] _{data} is being crossed. It is noted that multiple rules can be employed. For example, considering [symbol] _{data} perimeter, an additional rule could be [(sₙ, isSubClassOf, Process), (pₙ, isSubClassOf, (isReadBy, isExecutedBy))].
c. Then [symbol] ᵢ decorates activities with perimeter crossing information, so as to determine which PDP is to be evaluated.
d. It is noted that splitting policies according to semantic groups through the usage of perimeter types may only be required for performance reasons. More complex groupings may be used to improve performance. For instance, one may consider the more granular semantics involved in the policies than those specified by ZT and the typical policy evaluation frequency to define a perimeter hierarchy.
e. Each [symbol] ᵢ is associated to a corresponding PDP [symbol] ᵢ which is executed on top of the input activity tₙ.
f. If an activity does not match any semantic perimeter crossing type, then there is no need to authorize access for the particular activity.
g. To achieve maximum flexibility, more than one perimeter semantics may be crossed by a single activity tₙ.

### 4. Policy Decision Point:

a. Policy Engine, and Operations (4a)
i. A policy engine 406 may be linked to a corresponding access authorization policy database 408. Any policy pⱼ inserted to the access authorization policy database 408 may have to be compliant with the [symbol] ᵢ reasoning rule. If a [symbol] ᵢ match to policy pⱼ cannot be found, then either a new [symbol] ⱼ and [symbol] ⱼ pair must be defined or the [symbol] ᵢ semantics of the corresponding perimeter [symbol] ᵢ must be adapted. This is enough to ensure that [symbol] ᵢ semantics are always in sync with the policies employed.
ii. The policy engine 406 may ensure that activity tₙ is compliant with PDP [symbol] ᵢ the access authorization policy database 408 by checking that they comply with policy pⱼ.
iii. Some policies may require additional information from the activity database 402. Let Tⱼ denote a motif (a limited set of activities in the full KG) from the activity database 402 that are related to tₙ
iv. As a naïve policy embodiment, an embodiment may write queries to the activity database 402 that start from the tₙ activity and may ensure that the linked information Tⱼ is compliant if the query matches. For instance, suppose a data perimeter is being evaluated for an activity tₙ (Firefox, deletes, /tmp/slqBleMp) and policy pⱼ requires that user associated with Firefox process is from group G. Then considering the ontology example, policy pⱼ can simply evaluate whether [(U, is_a, user), (G, is_a, group), (sₙ, is_a, Process), (sₙ, hasUser, U), (U, hasGroup, G)]. Note that sₙ is Firefox in tₙ.
v. A policy may comprise a combination of various features and elements so as to obtain the benefit of the most appropriate technology for a policy evaluation goal. In an embodiment, simpler and faster rules may be evaluated before more complex rules, and may ensure activity control using low latency evaluations.
vi. More complex approaches may be employed to estimate missing information in Tⱼ or to dynamically determine the policy decision based on the network state through the computation of embeddings in the activity database 402. An embodiment may employ graph-based ML models to achieve such behaviors.
vii. As soon one policy matches: the policy engine 406 may inform a policy administrator 410 that a perimeter has been invaded or crossed, as determined by policy pⱼ.
viii. The policy engine 406 may also enriches the activity database 402 with information about the perimeter violation. We denote it as Vⱼ, a set of triples that are decorated to the activity database 402 which may enable the next evaluation performed by the policy engine 406 to be aware of any previous violations. These previous violations may be used to trigger policies resulting in more severe consequences for the entities involved or relying on more complex algorithms in order to investigate further affected entities in the network.
ix. The policy evaluation process may continue even if a policy is triggered. This approach may thus enable sequential evaluation of more complex policies and eventually determine more severe consequences to be employed due to the perimeter violation. Some policies may only be evaluated after a particular one is triggered.
x. If the evaluation finishes without a policy failing to match, this result may be deemed to indicate that the PDP [symbol] ᵢ has determined that the tₙ activity is allowed in the network.
   b. Policy Administrator, and Operations (4b)
i. Similar to the case of the policy engine 406, the policy administrator 410 may have access to the activity database 402 to obtain related information that enriches tₙ with relevant information.
ii. For example, let Tⱼ′ denote the motif required for evaluating the confinement rules. Note that in a simpler policy and confinement rule embodiments, it is possible that Tⱼ′=Tⱼ. In such cases, an embodiment may avoid further computations by simply propagating Tⱼ from the policy engine to the administrator.
iii. Each policy pⱼ is associated with a confinement rule cⱼ available in a confinement database 412 which, in one embodiment may be combined together with the access authorization policy database 408 to form a single database.
iv. The purpose of a confinement rule cⱼ is to determine how to handle the activity tₙ that resulted in the crossing of perimeter [symbol] ᵢ as determined by policy pⱼ.
v. In contrast with the policy engine 406, the policy administrator 410 may also be required to have access to an enforcement points database 414 to determine what enforcements points are available. Let eₗ denote an available PEP.
vi. The confinement rule cⱼ may be expected to have compound form cⱼ={cⱼ⁽¹⁾, . . . , cⱼ⁽ⁿ⁾}, where cⱼ⁽¹⁾ is more permissive than cⱼ⁽ⁿ⁾.
vii. The confinement rules are associated to a premise in which they are valid, with the possible feature of implementing the confinement rules in the form of an ontology reasoning framework. That is, let vⱼ⁽ⁱ⁾ be the premise of confinement rule cⱼ⁽ⁱ⁾, then such rule is only to be applied if vⱼ⁽ⁱ⁾(tₙ, eₗ) matches.
viii. Then confinement rule cⱼ⁽ⁱ⁾(tₙ, eₗ) specifies the request rₗ to be sent to eₗ dedicated to control the unauthorized crossing of perimeter [symbol] ᵢ.
ix. Finally, vⱼ⁽ⁿ⁾ may be expected to hold for at least one eₗ for any possible tₙ capable of triggering policy pⱼ. The corresponding confinement rule may, in an embodiment, be expected to be very strict: for example, revoke access of a primary entity or set of primary entities from the network.
   c. Policy Decision Point
As further indicated in the example of FIG. 4, a policy decision point (PDP) 416 may be defined that comprises the policy engine 406, access authorization policy database 408, the policy administrator 410, and the confinement database 412.

### 5. Policy Enforcement Point

a. In an embodiment, a PEP eₗ 418 receives (5) the request rₗ of a PDP [symbol] ᵢ and perform modifications in the network to ensure that the confinement rule is respected. These may include denial or revocation of access of an entity activity within [symbol] ᵢ boundary, but also several actions to handle the particular perimeter crossing actions.
b. If its attempts fail or result in a time out, the PEP 418 may return such information to the policy administrator 410 so that a more severe confinement strategy may be employed.
c. In one embodiment, the total time to respond to an unauthorized crossing of the perimeter [symbol] ᵢ is the time difference from when eₗ successfully complied to request rₗ to the time when the initial activity occurred. Various mechanisms may be used to avoid an attacker from exploiting lazy evaluation properties of ADP. Following are some examples of such mechanisms:
   i. Near real-time operation: current KG technology may result in really small latency in a way that the system can, in practice, have the same result as an SDP-based PEP and prevent nearly any substantial operation from taking place within or across a perimeter if access to a perimeter is unauthorized. For example, a carefully tweaked KG implementation for security application managed to achieve latency of a few milliseconds in online operation while performing hundreds of thousands of evaluations per second, as disclosed in “Nebula Graph, ‘How to Handle Tens of Billions of Threat Intelligence Data in a Graph Database.’ 2022. [Online]. How to Handle Tens of Billions of Threat Intelligence Data in a Graph Database|by NebulaGraph Database|ITNEXT,” which is incorporated herein in its entirety by this reference.
ii. Reducing the trust confidence levels of the associated entity: the PEP 418 may have additional policies impacting the trust confidence levels. This way, an entity continuously attempting to move beyond an allowed perimeter will eventually have access to the network revoked.
iii. Adaptable tolerance of breaking boundaries: some perimeters can result in less tolerance to intrusion than others, for example, leading to valuable resources, and these can be made adaptable: perimeters constantly being attempted to be crossed can lead to faster access revocation.
iv. Reset to nearest snapshot: when ADPs are employed to non-critical resources, they can be restored to the state of the nearest backup state available.
v. Follow traces of activities of entities breaking boundaries and ensure to remove any residual: whenever observability allows, ensure to remove all residuals and modifications performed by the entity breaking perimeters.

### D. Example Methods

It is noted with respect to the disclosed methods, including the example method of FIG. 4, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments of the invention. These are presented only by way of example and are not intended to limit the scope of the invention in any way.

Embodiment 1. A method, comprising: collecting telemetry concerning an activity occurring in an IT infrastructure; updating an activity database with the telemetry; applying a rule to determine if the activity is associated with a crossing of an analytics-defined perimeter (ADP) within the IT infrastructure; when a perimeter crossing has been determined to have occurred, applying a policy to determine whether, and what, action should be taken with respect to the perimeter crossing; and implementing an action with respect to an entity whose activity is being evaluated when the perimeter crossing is determined to be contrary to the policy.

Embodiment 2. The method as recited in any preceding embodiment, wherein the ADP crossing is verified directly through the policy.

Embodiment 3. The method as recited in any preceding embodiment, wherein the perimeter defines a segment of the IT infrastructure.

Embodiment 4. The method as recited in any preceding embodiment, wherein the ADP is defined without use of direct intervention in an IT infrastructure.

Embodiment 5. The method as recited in any preceding embodiment, wherein the ADP determines a conditional access authorization for the entity based on a network state representation.

Embodiment 6. The method as recited in any preceding embodiment, wherein the ADP is defined without use of a local policy enforcement point (PEP).

Embodiment 7. The method as recited in any preceding embodiment, wherein the rule and policy are represented as data in a database.

Embodiment 8. The method as recited in any preceding embodiment, wherein the ADP is dynamically modifiable.

Embodiment 9. The method as recited in any preceding embodiment, wherein the action comprises restricting, or preventing, the entity from engaging in the activity outside of the perimeter.

Embodiment 10. The method as recited in any preceding embodiment, wherein the action is implemented by a PEP.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

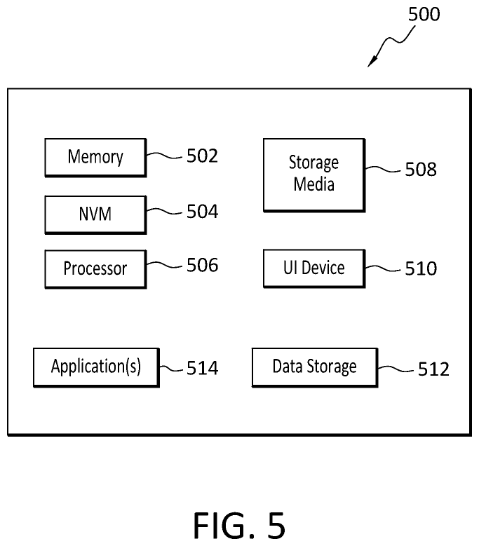

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
collecting telemetry concerning an activity occurring in an IT infrastructure;
updating an activity database with the telemetry;
applying a rule to determine if the activity is associated with a crossing of an analytics-defined perimeter (ADP) within the IT infrastructure;
when a perimeter crossing has been determined to have occurred, applying a policy to determine whether, and what, action should be taken with respect to the perimeter crossing; and
implementing an action with respect to an entity whose activity is being evaluated when the perimeter crossing is determined to be contrary to the policy.

2. The method as recited in claim 1, wherein the ADP crossing is verified directly through the policy.

3. The method as recited in claim 1, wherein the perimeter defines a segment of the IT infrastructure.

4. The method as recited in claim 1, wherein the ADP is defined without use of direct intervention in an IT infrastructure.

5. The method as recited in claim 1, wherein the ADP determines a conditional access authorization for the entity based on a network state representation.

6. The method as recited in claim 1, wherein the ADP is defined without use of a local policy enforcement point (PEP).

7. The method as recited in claim 1, wherein the rule and policy are represented as data in a database.

8. The method as recited in claim 1, wherein the ADP is dynamically modifiable.

9. The method as recited in claim 1, wherein the action comprises restricting, or preventing, the entity from engaging in the activity outside of the perimeter.

10. The method as recited in claim 1, wherein the action is implemented by a PEP.

11. A non-transitory storage medium having stored therein instructions that are executable by one or more hardware processors to perform operations comprising:
collecting telemetry concerning an activity occurring in an IT infrastructure;
updating an activity database with the telemetry;
applying a rule to determine if the activity is associated with a crossing of an analytics-defined perimeter (ADP) within the IT infrastructure;
when a perimeter crossing has been determined to have occurred, applying a policy to determine whether, and what, action should be taken with respect to the perimeter crossing; and
implementing an action with respect to an entity whose activity is being evaluated when the perimeter crossing is determined to be contrary to the policy.

12. The non-transitory storage medium as recited in claim 11, wherein the ADP crossing is verified directly through the policy.

13. The non-transitory storage medium as recited in claim 11, wherein the perimeter defines a segment of the IT infrastructure.

14. The non-transitory storage medium as recited in claim 11, wherein the ADP is defined without use of direct intervention in an IT infrastructure.

15. The non-transitory storage medium as recited in claim 11, wherein the ADP determines a conditional access authorization for the entity based on a network state representation.

16. The non-transitory storage medium as recited in claim 11, wherein the ADP is defined without use of a local policy enforcement point (PEP).

17. The non-transitory storage medium as recited in claim 11, wherein the rule and policy are represented as data in a database.

18. The non-transitory storage medium as recited in claim 11, wherein the ADP is dynamically modifiable.

19. The non-transitory storage medium as recited in claim 11, wherein the action comprises restricting, or preventing, the entity from engaging in the activity outside of the perimeter.

20. The non-transitory storage medium as recited in claim 11, wherein the action is implemented by a PEP.
